(19) United States
(12) Patent Application Publication
(10) Pub. No.: US 2013/0134689 A1
(43) Pub. Date: May 30, 2013

(54) Tow Line/Strap Assembly

(71) Applicant: Antonio Juan Barajas, Alvin, TX (US)

(72) Inventor: Antonio Juan Barajas, Alvin, TX (US)

(21) Appl. No.: 13/305,623

(22) Filed: Nov. 28, 2011

(51) Int. Cl. B60D 1/18

(52) U.S. Cl. 280/480

(57) ABSTRACT

A line and/or strap assembly allowing for easily towing of motorcycles is disclosed. The assembly is attached to the fork tubes of the motorcycles on one end and the towing vehicle on the opposite end.

### BACKGROUND OF THE INVENTION

Motorcycles are one of the most affordable forms of motorized transport in many parts of the world. The frame of a motorcycle is usually created from welded steel, alloy, or aluminum struts, with rear suspension being an integral component in the design. The frame includes the head tube that holds the front fork and allows it to pivot. Some motorcycles include the engine as a load-bearing member. A motorcycle fork or front fork is the portion of a motorcycle that holds the front wheel and allows one to steer. A fork consists of two fork tubes which attach a motorcycle's front wheel to the frame with a pair of triple clamps. A triple tree attaches the fork tubes to the frame. The handlebars are connected to the frame by a triple tree which creates a pivot that allows for steering.

### FIELD OF THE INVENTION

The present invention relates to line and/or strap assemblies used for towing motorcycles.

### SUMMARY OF THE INVENTION

The subject of the present invention is directed to a new towing device for motorcycles that provides an easy and efficient method of towing a motorcycle that is

As will be appreciated by those persons skilled in the art, a major advantage provided by the present invention is an attachment device that overcomes the aforementioned shortcomings of prior devices. Additional objects of the present invention will become apparent from the following description.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is a perspective view of a preferred embodiment of the present invention attached to the motorcycle.

FIG. 2 is a cutaway of towing device.

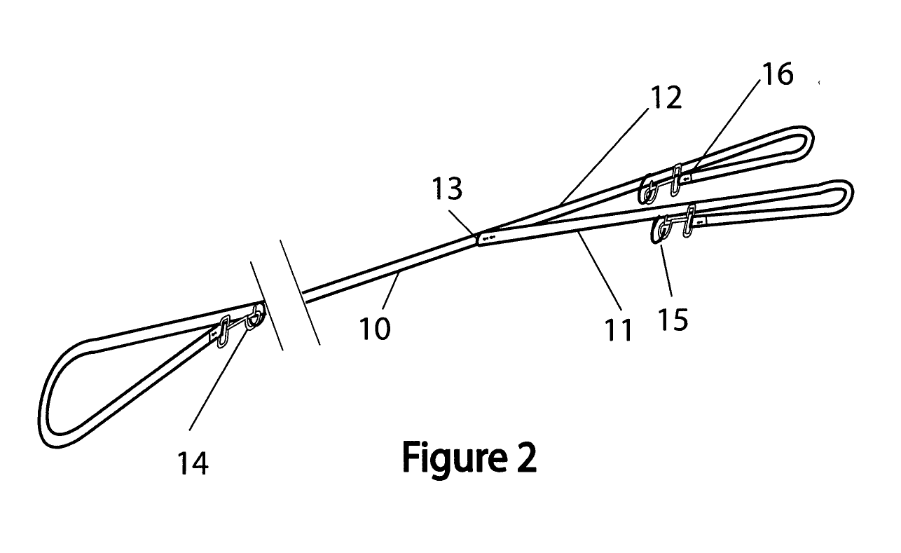

FIG. 3 is the towing device attached to the motorcycle and the towing vehicle.

The method and apparatus of the present invention will be better understood by reference to the following detailed discussion of specific embodiments and the attached figures which illustrate and exemplify such embodiments.

### DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

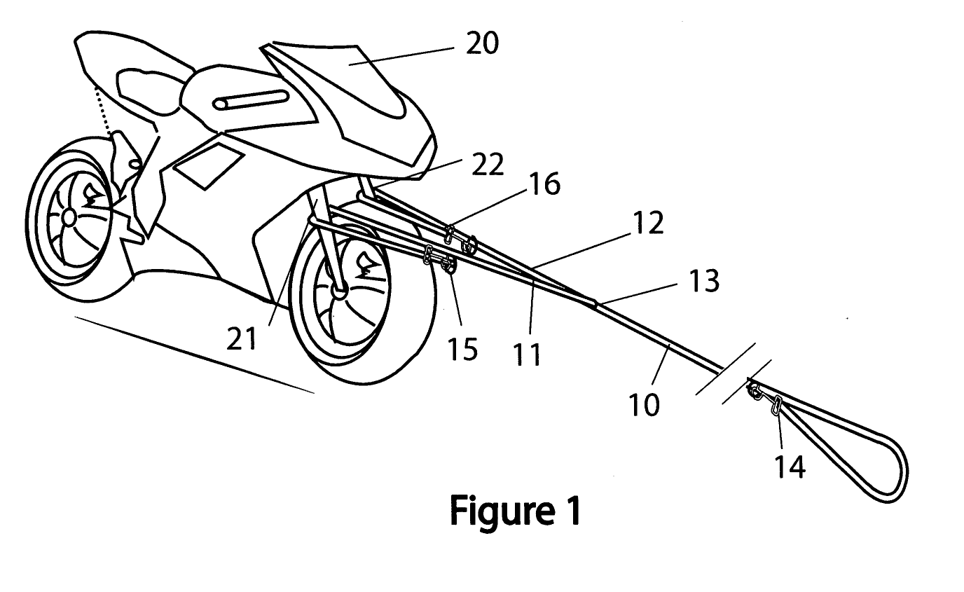

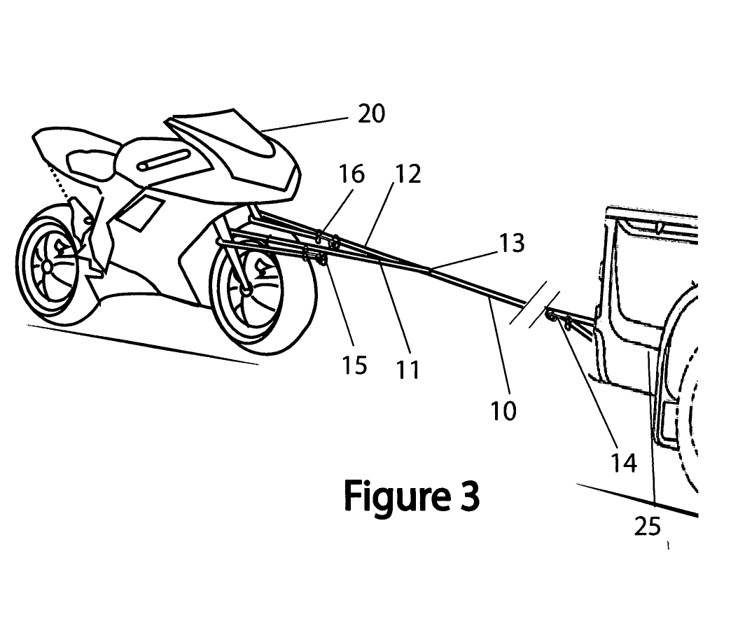

A motorcycle fork connects a motorcycle's front wheel and axle to its frame via a pair of triple clamps. The fork incorporates the front suspension and front brake. The fork allows the bike to be steered with the handlebars attached to the top clamp. The fork and its attachment points on the frame establish the critical geometric parameters of rake and trail, which play a major role in defining how a motorcycle handles and drives during braking. Towing device of the present invention works in conjunction with the forks to allow the motorcycle to be steered while in tow. Referring to FIG. 3, first pulling line(10) is attached to towing vehicle (25) by first attaching element(14) which can be hooks, shackles or other suitable attaching devices. As depicted in FIG. 1, second towing line (11) and third towing line (12) are attached to fork tubes (21, 22) of the motorcycle (20) to be towed using second attaching element (15) and third attaching element (16) which can be hooks, shackles or other suitable attaching devices. Motorcycles are normally towed with a rider thereon. Thus, apex point (13) is securely attached to the front end of first pulley line (10). Allowing the motorcycle (20) balance is kept while in tow using vehicle (25) .

Although the particular embodiments shown and described above will prove to be useful in many applications in the towing and the hauling arts to which the present invention pertains, further modifications of the present invention will occur to persons skilled in the art. All such modifications are deemed to be within the scope and spirit of the present invention as defined by the appended claims.

What is claimed is:

1. A towing device comprising:
a first line defined by a first end, an apex point, and an opposite second end;
a first attaching element operationally coupled to the first end;
a second attaching element operationally coupled to the opposite second end;
the apex point centrally located on the first line;
a second line at one end fixably attached to the apex point wherein the first line forms a triangular shape;
the first and second attaching element for attaching to a pair of fork tubes of the motor cycle;
the second line extending linearly from the apex point to a second end attached to a third attaching element wherein the first line forms a triangular shape when attached to the pair of fork tubes of the motorcycle;

2. The towing device of claim one wherein the first attaching element is removable.

3. The towing device of claim one wherein the second attaching element is removable.

4. The towing device of claim one wherein the third attaching element is removable.

5. The towing device of claim 1 wherein the first and second line is cables or straps;

6. The towing device of claim 5 wherein the cables or straps are multi-stranded.

7. The towing device of claim 1 wherein the first attaching element is a hook fastener.
